(19) United States
(12) Patent Application Publication
(10) Pub. No.: US 2013/0051307 A1
(43) Pub. Date: Feb. 28, 2013

(54) Method, a relay node and an apparatus for random access

(71) Applicant: Jianke FAN, Espoo (FI)

(72) Inventor: Jianke FAN, Espoo (FI)

(73) Assignee: Renesas Mobile Corporation

(21) Appl. No.: 13/199,398

(22) Filed: Aug. 29, 2011

(30) Foreign Application Priority Data
Aug. 23, 2011 (GB) 1114599.2

(51) Int. Cl. H04W 88/04

(52) U.S. Cl. 370/315

(57) ABSTRACT

A method, an apparatus for wireless communication and a relay node for wireless radio communication. According to the invention the method includes setting a random access message format for establishing a connection between an apparatus for wireless communication and a relay node, the random access message format including a first, a second and a third portion: the first portion including information of the size of a cyclic prefix, the second portion including the size of random access information, and the third portion including guard time information; transmitting information about the random access message format consisting of the second portion and the third portion, prestoring in a memory a value for the first portion, receiving a second portion of a random access message, and detecting a received random access message based on the prestored value for the first portion, and on the received second portion.

### FIELD OF THE INVENTION

The invention relates to mobile communication networks. More specifically, the invention relates to the radio interface and the random access to a relay node in LTE.

### BACKGROUND OF THE INVENTION

3GPP, 3rd Generation Partnership Project, develops specifications for third generation mobile phone systems, and also from Release 8 (Rel-8) the next generation specifications often referred to as LTE, Long Term Evolution. LTE-Advanced is a technology featured in Release 10. LTE-Advanced has introduced the usage of relay nodes, which are used to enhance the coverage area of the base station eNB, evolved Node B.

Random access transmission is the only non-synchronized transmission in the LTE uplink. The terminal cannot determine its distance from the base station, thus causing a timing uncertainty from the two way propagation delay on Random Access Channel transmissions.

The timing uncertainty is highlighted with a relay node, which has synchronized its transmission in two different cells with significantly different sizes: the relay node cell and the eNB cell to which it is connected, DeNB (Donor evolved Node B). The Random Access procedure starts by the user equipment sending a random access preamble via Physical Random Access Channel (PRACH). The random access preamble is sent to the network in non-synchronized mode, allowing the user equipment to synchronize timing with the eNodeB or with the Relay Node.

According to Rel-8, five different preamble formats have been specified, where the preamble format is selected based on the network cell size. An example of preamble formats is presented in 3GPP publication TS 36.211 V9.1.0 (2010-03), paragraph 5.7.1, Table 5.7.1-1, also presented as FIG. 1 in this document. Each preamble format has three parts: cyclic prefix, preamble sequence and guard time.

In the Relay Node enhanced network Relay Nodes may be located near the eNB cell edge to improve signal strength and network performance. The preambles according to Rel-8 may cause the user equipment preambles to overlap subframes, especially in small Relay Node cells—pico cells or micro cells. Avoiding interference between other uplink transmissions would lead to reserving double subframes for Random Access Channel preamble transmission. As a result, uplink resources are not used optimally. A longer preamble would also result in consuming additional uplink resources.

### PURPOSE OF THE INVENTION

The purpose of the invention is to present a method, a relay node and an apparatus for wireless communication that utilize uplink resources effectively during the user equipment's random access procedure.

### SUMMARY

The invention discloses a method in wireless radio communication involving a relay node. The method comprises setting a random access message format for establishing a connection between an apparatus for wireless communication and a relay node, the random access message format comprising a first, a second and a third portion: the first portion comprising information of the size of a cyclic prefix, the second portion comprising the size of random access information, and the third portion comprising guard time information; transmitting information about the random access message format consisting of the second portion and the third portion, prestoring in a memory a value for the first portion, receiving a second portion of a random access message and detecting a received random access message based on the prestored value for the first portion, and on the received second portion. The random access message format comprises a first portion that is not transmitted in the random access message. The received random access message is detected by receiving only the second portion, by using the first portion that is stored only in the relay node.

In an exemplary embodiment the random access message is a preamble. The preamble format is selected from a group of preamble formats dedicated for wireless apparatus access.

In one exemplary embodiment the size of the first portion is based on the round trip delay between the relay node and the donor base station. The guard time is based on the distance between the relay node and the donor base station and the size of the relay node cell.

In one exemplary embodiment the preamble comprises Physical Uplink Shared Channel and Physical Uplink Control Channel transmission if the resource granting system allows granting subframe fractions in time.

In one exemplary embodiment the Physical Uplink Shared Channel and Physical Uplink Control Channel transmission is received from a second apparatus for wireless communication during the period assigned for the first portion.

In another aspect of the invention the relay node for wireless radio communication is configured to set a random access message format for establishing a connection between an apparatus for wireless communication and the relay node, the random access message format comprising a first, a second and a third portion: the first portion comprising information of the size of a cyclic prefix, the second portion comprising the size of random access information, and the third portion comprising guard time information; transmit information about the random access message format consisting of the second portion and the third portion, prestore in a memory a value for the first portion, receive a second portion of the random access message, and detect a received random access message based on the prestored value for the first portion, and on the received second portion.

In one exemplary embodiment the relay node is configured to select the preamble format from a group of preamble formats dedicated for wireless apparatus access.

In one exemplary embodiment the relay node is configured to receive a preamble comprising Physical Uplink Shared Channel and Physical Uplink Control Channel transmission if the resource granting system allows granting subframe fractions in time.

In one exemplary embodiment the relay node is configured to receive Physical Uplink Shared Channel and Physical Uplink Control Channel transmission from a second apparatus for wireless communication during the period assigned for the first portion.

In another aspect of the invention the apparatus for wireless communication is configured to receive information of a random access message format for establishing a connection between the apparatus for wireless communication and a relay node, the information disclosing the random access message format comprising a first, a second and a third portion and that only the second and third portion shall be transmitted, and where the first portion comprises information of the size of a cyclic prefix, the second portion comprises the size of random access information, and the third portion comprises guard time information based on the distance between the relay node and the donor base station and the size of the relay node cell; generate a random access message based on the random access message format information; and transmit to the relay node the random access message in a format without the first portion.

In one exemplary embodiment the apparatus for wireless communication is configured to operate as part of a user equipment. Examples of a user equipment are a mobile phone, a mobile computing device such as PDA, a laptop computer, a USB stick—basically any mobile device with wireless connectivity to a communication network.

In one exemplary embodiment the apparatus is configured to select the preamble format from a group of preamble formats dedicated for wireless apparatus access. In one exemplary embodiment the apparatus is configured to send a preamble comprising Physical Uplink Shared Channel and Physical Uplink Control Channel transmission if a resource granting system allows granting subframe fractions.

In one exemplary embodiment the apparatus is configured to receive Physical Uplink Shared Channel and Physical Uplink Control Channel transmission during the period of the first portion from a second apparatus for wireless communication. The random access message format that does not send the first portion or the cyclic prefix via the radio transmission allows other wireless apparatuses to use the radio resource during the period assigned for the first portion.

According to the invention the apparatus for wireless communication does not send the cyclic prefix with the preamble. The relay node comprises information about the cyclic prefix and is able to detect the random access preamble without the apparatus transmitting the cyclic prefix.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates random access preamble formats according to prior art,

FIG. 2 is a block diagram illustrating the network elements,

FIG. 3 illustrates an example of random access preamble formats according to the invention,

FIG. 4 is a timing diagram illustrating the timing misalignment in a network utilizing a relay node,

FIG. 5a is a block diagram of a preamble format according to prior art,

FIG. 5b is a block diagram of a preamble format according to the invention, and

FIG. 6 is a timing diagram illustrating the improved timing with a preamble format according to the present invention.

### DETAILED DESCRIPTION OF THE INVENTION

Reference will now be made in detail to the exemplary embodiments of the present invention, examples of which are illustrated in the accompanying drawings.

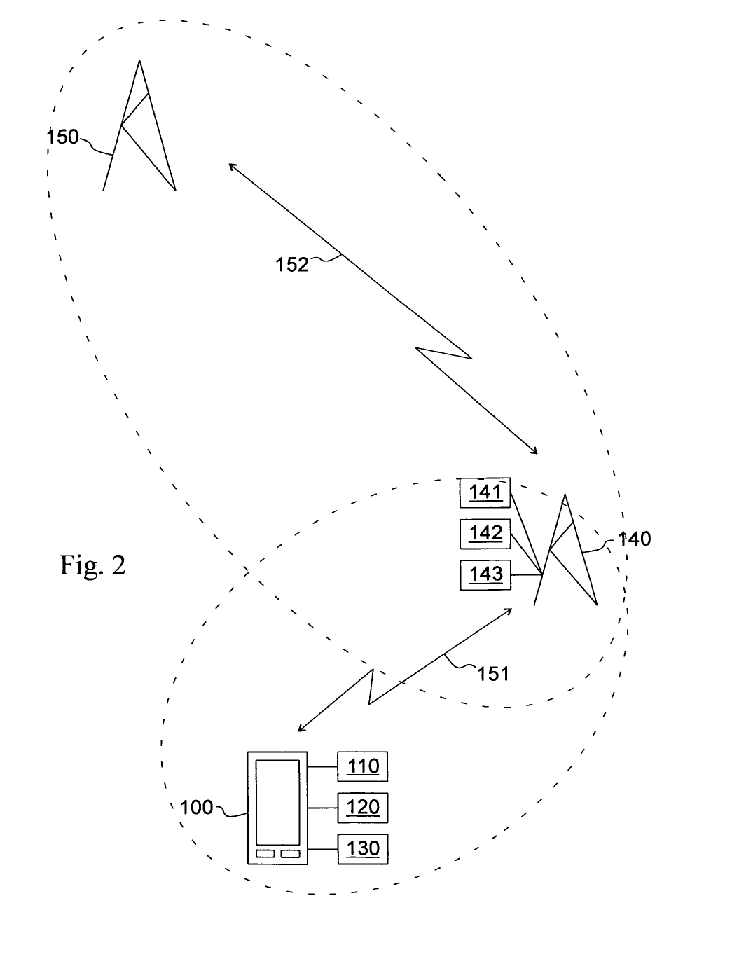

FIG. 2 is a block diagram illustrating an apparatus 100 according to an exemplary embodiment connected to a mobile communication network. The apparatus 100 comprises at least one controller 110, such as a processor, a memory 120 and a communication interface 130. In one exemplary embodiment the apparatus is a computer chip. Stored in the memory 120 are computer instructions which are adapted to be executed on the processor 110. The communication interface 130 is adapted to receive and send information to and from the processor 110. The apparatus 100 is commonly referred to as user equipment.

The user equipment 100 is connected via a relay node 140 to a base station 150, the connection being formed by radio links 151, 152. The base station 150 may be an enhanced Node B, eNB, and when acting in connection with the relay node, a Donor enhanced Node B, DeNB. From the user equipment's 100 perspective the relay node offers the functionality required to connect to the wireless network.

The relay node 140 comprises at least one controller 141, such as a processor, a memory 142 and a communication interface 143. In one exemplary embodiment the relay node comprises a computer chip executing the functionality according to the invention. Stored in the memory 142 are computer instructions which are adapted to be executed on the processor 141. The communication interface 143 is adapted to receive and send information to and from the processor 141.

The base station eNB 150 is adapted to be part of a cellular radio access network such as E-UTRAN applying WCDMA technology or similar networks suitable for high speed data transmission. Such networks are often also referred to as 4G or LTE. In this example the cellular radio access network supports carrier aggregation comprising LTE and HSPA. The base station 150 illustrated in FIG. 2 symbolizes all relevant network elements required to carry out the functionality of the wireless network.

In an exemplary scenario of the functionality according to the invention, the relay node comprises the relevant information for selecting a preamble format: the relay node cell size and the distance between the relay node and DeNB. The relay node may send the preamble index, i.e. the selected preamble format and other relevant parameters over higher layers than the physical channel. One example of this is described in the 3GPP document TS 36.213 V9.3.0 (2010-09, Section 6.1. The invention is not limited to LTE or LTE Advanced as defined by the 3GPP, as these technologies are used in the context of an exemplary embodiment. The invention may also be used in any wireless communication system applying network elements or wireless apparatuses comprising similar characteristics or functionalities as the present invention.

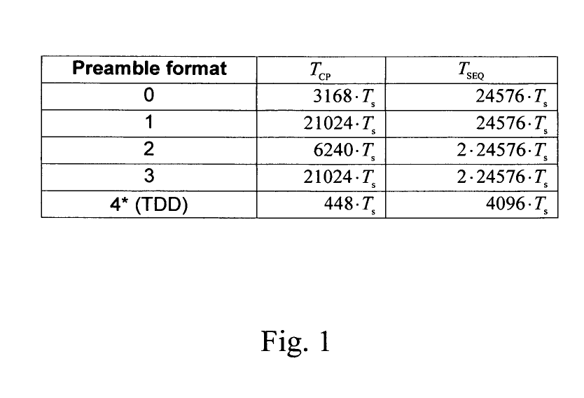

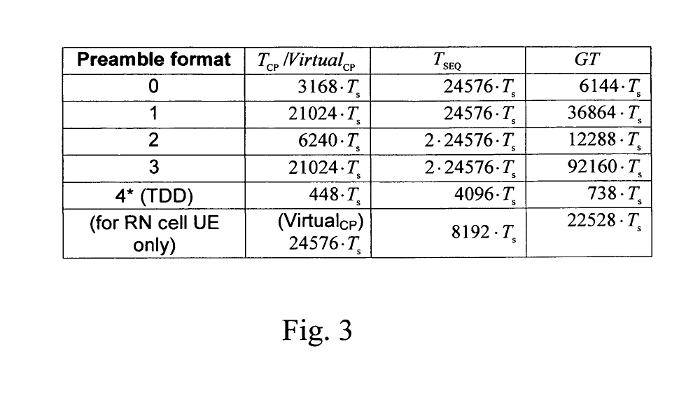

According to the invention, a sixth preamble format is added to the preamble table of FIG. 1. This new preamble table is available for the relay node and the user equipment. One example of the new preamble table is illustrated in FIG. 3.

As the user equipment is turned on in the relay node cell, it has no information about the network and starts listening to the broadcasting channel in order to begin the random access procedure; locating the radio raster it is able to camp on, starting a contention-based RACH procedure and measuring its timing advance TA command. The user equipment receives the basic parameters about the preamble format. By using the preamble format lookup table the user equipment selects a suitable preamble format and calculates the preamble sequence from the received parameters.

The user equipment starts the communication by sending the preamble to PRACH, Physical Random Access Channel, which carries the random access preamble to access the network in non-synchronized mode. This allows the user equipment to synchronize timing with the relay node. According to the invention the preamble sent contains only the preamble sequence and a guard time GT, not the cyclic prefix.

The relay node already comprises the information related to the cyclic prefix, so it does not need to receive the cyclic prefix via the radio interface to detect the preamble sequence.

The present specification for preamble formats may cause a timing misalignment problem for the relay node in the LTE network. In a relay enhanced network the relay node cell is usually a small sized cell such as a pico or a micro cell, and ISD (Inter Site Distance) between the DeNB and the relay node can be rather large. The LTE system according to the proposed specification has five preamble formats as seen in FIG. 1. The preamble format is selected based on the network cell size. The maximum cell size is up to 107 km. Each preamble format comprises three portions: the first portion is the cyclic prefix (CP), the second portion is the preamble sequence and the third portion is the guard time (GT). The preamble sequence is placed in the middle in the preamble format; cyclic prefix CP and guard time GT on the two sides reflect cell size.

As the user equipment transmits a contention-based preamble sequence to a network node, it detects PRACH preambles in an associated subframe or subframes based on the preamble format. In the relay node enhanced network, the relay node is used for user equipments located close to the eNB cell edge to enhance the signal strength and to improve the network performance. According to 3GPP specification 36.216, the relay node cell downlink timing can be aligned with the reception of DeNB signal, while the relay node cell uplink timing can be aligned with DeNB cell uplink timing. In the FDD (Frequency Division Duplex) mode several delays are formed after the relay node has signed in to the DeNB and starts receiving the accessing request from a user equipment R-UE. At least round trip delays of the relay node backhaul and access procedure are created between the downlink reception timing and the uplink transmission timing of the R-UE. This results to larger uplink timing advance TA for the relay node attached user equipment R-UE than in the normal circumstances. When the user equipment R-UE is sending PRACH preambles following Rel-8 preamble design and definitions, the preambles may cross the boundary of the uplink subframes due to the additional delay and overlap partly with two uplink subframes. This timing misalignment may occur even in small relay node cells.

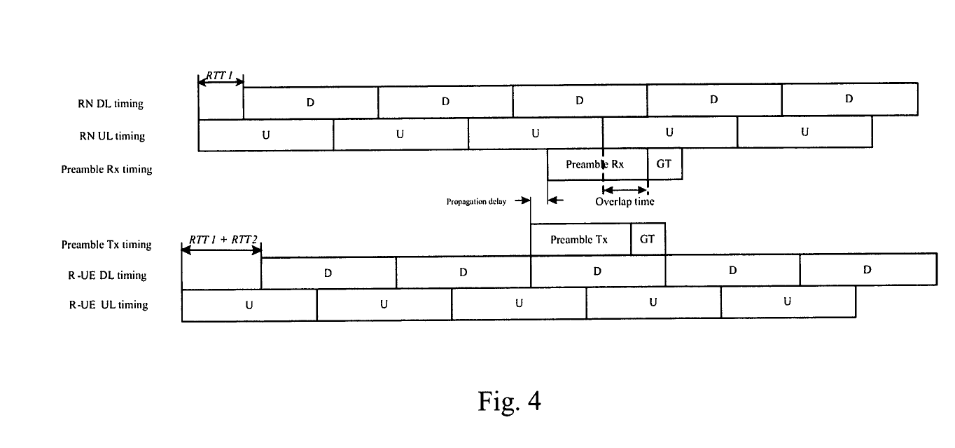

An example of the timing misalignment is illustrated in FIG. 4. The preamble is illustrated from both the user equipment's perspective and from the relay node's perspective. The preamble transmitted at the third uplink subframe at the user equipment crosses the 3rd and 4th subframe boundary. In this example avoiding the interference between other uplink transmissions results in reserving double subframes to ensure correct reception of the RACH preamble.
RN DL timing=relay node downlink timing;
RN UL timing=relay node uplink timing;
R-UE DL timing=user equipment downlink timing;
R-UE UL timing=user equipment uplink timing;
Preamble Rx=relay node reception of the preamble;
Preamble Tx=relay node transmission of the preamble;
GT=Guard Time;
RTT1=Round Trip Time between the DeNB and the relay node;
RTT2=Round Trip Time between the relay node and the user equipment;
D=downlink subframe;
U=uplink subframe

According to the invention a new preamble format is introduced to user equipments attempting random access to relay node. A guard time is assigned by considering the eNB cell size and the relay node cell size, the preamble sequence is assigned as standard and the cyclic prefix is not assigned. A virtual cyclic prefix at the relay node detects the preamble sequence. The virtual cyclic prefix is equal to the inter-site distance ISD between the DeNB and the relay node. The solution is applicable in both Time Division Duplex TDD and Frequency Division Duplex FDD.

In the preamble design according to prior art the guard time (GT) of a RACH preamble is an empty space having no transmission, located at the end of the random access timeslot. The guard time functions to cover the initial timing misalignment of the uplink transmission due to the propagation round-trip delay.

In a relay node enhanced network the relay cell is usually a small Pico or Micro cell and the Inter-Site Distance ISD between the DeNB and the relay node can be rather large. The preamble formats according to prior art might not meet the requirements for meeting the relay cell propagation delay, thus it might not be sufficient to avoid the initial timing misalignment issue.

According to the present invention a virtual total round trip delay between the DeNB and the relay node with the round trip delay between the user equipment and the relay node are considered into the guard time and assigned to the user equipment for RACH preamble transmission.

Normally a cyclic prefix of a RACH preamble is a copy of the end of the preamble sequence that is added to the beginning of the sequence in order to make the received signal periodic for frequency domain correlation. The length of the cyclic prefix reflects the RN cell radius of the round trip delay between the user equipment and the relay node. In a relay node cell, if the user equipment is sending an access request to the relay node via its uplink subframe, the relay node would be communicating at backhaul link to DeNB at its assigned backhaul subframe. If the relay node cell downlink timing is aligned with the reception of DeNB signal while the relay node cell uplink timing is aligned with DeNB cell uplink timing, there would be a “gap” of at least RoundTripDelay_backhaul+RoundTripDelay_access between downlink reception timing and uplink transmission timing of the user equipment. By selecting the preamble format according to prior art specification rules, part of the preamble would be out of the random access detection domain.

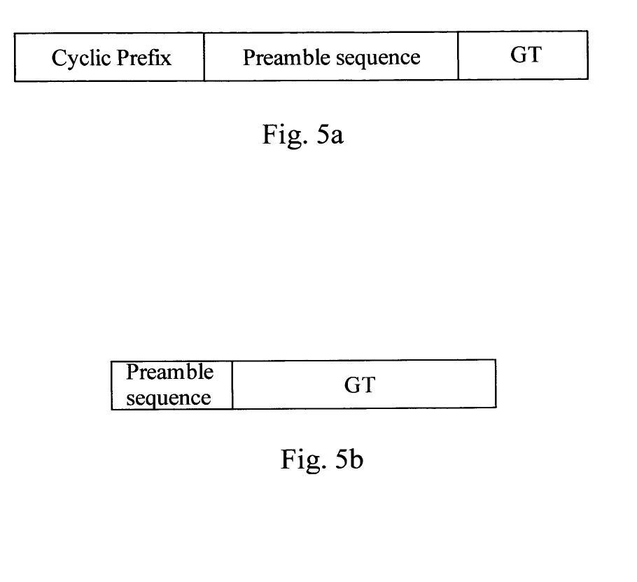

The preamble format according to prior art is illustrated in FIG. 5a, comprising all three portions; Cyclic Prefix CP, Preamble and Guard Time GT. The lengths of the Cyclic Prefix CP and the Guard Time GT are fairly close to each other, reflecting the round trip delay of the cell. The new preamble format does not contain the Cyclic Prefix CP part, as illustrated in FIG. 5b, and also the preamble portion may be much shorter compared to prior art. When the user equipment sends initial access request it is assigned by the relay node with a new preamble format that considers the virtual total guard time plus the preamble energy strength. The preamble sequence could be a standard sequence according to the current specification. The new preamble format does not have the cyclic prefix part, but instead a “virtual cyclic prefix” equal to the round trip delay between the eNB and the relay node at RN when detecting the preamble sequence. The round trip delay between the eNB and the relay node is known information to the relay node. Therefore it is possible for the relay node to detect a preamble signal at the frequency domain. By forming a random access preamble structure the selected preamble has considered the “gap” that created the timing misalignment issue (i.e., taking the guard time into account) and solves the preamble detection deterioration problem.

For example, based on 1 ms preamble format 0 in Table 1, with the present invention it is possible to form a random access preamble structure, wherein a preamble sequence of 0.8 ms is assigned. The guard time is 6144*Ts (0.2 ms) meaning 30 km of total cell size. The guard time is obtained by calculating:

T_{—}GT=2* (RelayCellRadius+ISDeNBRelay)/C

or

T_{—}GT=2* (RoundTripDelay UE-RN+RoundTripDelay eNB-RN)/C

In a typical relay cell radius in the order of 6.6 km or less there would be a virtual cyclic prefix of 23.4 km reflecting the size of RoundTripDelay eNB-RN derived by subtracting relay cell size from the total cell size: 30 km−6.6 km=23.4 km. By this method all parts of the preamble at relay node would be within 1 ms subframe detection domain. Basically all existing preamble formats 0-3 defined in 36.211 can be reformed. However, adding only one new preamble format to existing preamble formats provides minimal changes to the specification and improves the compatibility of different generation wireless devices.

The relay node cells are typically pico or micro cells and the typical preamble format could be designed such that it could be specially used for serving relay node cell user equipments. As the number of user equipments in pico or micro cells is relatively low, leaving out the cyclic prefix does not create significant random access collision problems. Therefore, the preamble sequence without any cyclic prefix is particularly beneficial in the relay node random access procedure.

The preamble sequence Tseq needs to be long enough so that the power of the preamble satisfies the requirements of relay cell radius. The value of Tseq should also be an integer of Ts. Without the cyclic prefix part, without losing the preamble signal-to-noise ratio SNR and with an efficient way of making use of uplink resources, the solution meets R-UE's uplink initial timing misalignment requirements.

For example, a new preamble format 5 can be designed such that the length of the sequence would be Tseq=8192×Ts (267 us)=2×4096×Ts. It could be generated with 139 of Nzc of the Zadoff-Chu sequence. The format is almost 3 OS (Tseq=267) and would hence allow a larger guard time in a 1 ms subframe; 1 ms−0.267 ms=0.7 ms which supports total cell size of 110 km. For a relay cell radius of 6.6 km or larger, the virtual cyclic prefix of 103 km (110 km−6.6 km=103 km) is the maximum, or there would be 103 km of distance between DeNB and the relay node.

The current preamble specification has preamble formats numbered from 0 to 4; in this document the new preamble format is referred to as format 5. The preamble format 5 according to the present invention is suitable for most relay deployment scenarios as the typical relay node cell radius is in the order of 6.6 km (pico or micro RN cells) and the inter-site distance between DeNB and the relay node is in the order of 103 km (macro DeNB cells). FIG. 3 lists preamble parameters with the proposed preamble structure according to the invention for a relay cell size of 6.6 km.

Because the preamble format is rather short, it may leave a large part of the subframe unoccupied. These unoccupied parts could be utilized for PUCCH and PUSCH transmission if the resource granting system allows granting subframe fractions in time. If the inter-site distance of DeNB to relay node is large, the region that is free of RACH transmission could be several OFDMA symbols wide and could be located at the beginning of the subframe. In the case of a very small inter-site distance DeNB-RN, the free region could be seen at the end of the subframe so that the end of the guard time region could be used for other user equipment's PUCCH and PUSCH transmission. The new preamble format would thus be useful also in normal cells if a longer preamble is not needed for coverage. The benefit of this arrangement is present in the narrow system bandwidth. If RACH extends over large part of the bandwidth or over the full band, the fractional grants could be beneficial in order to avoid delays in PUCCH transmission and in order to save a relatively large part of the resources.

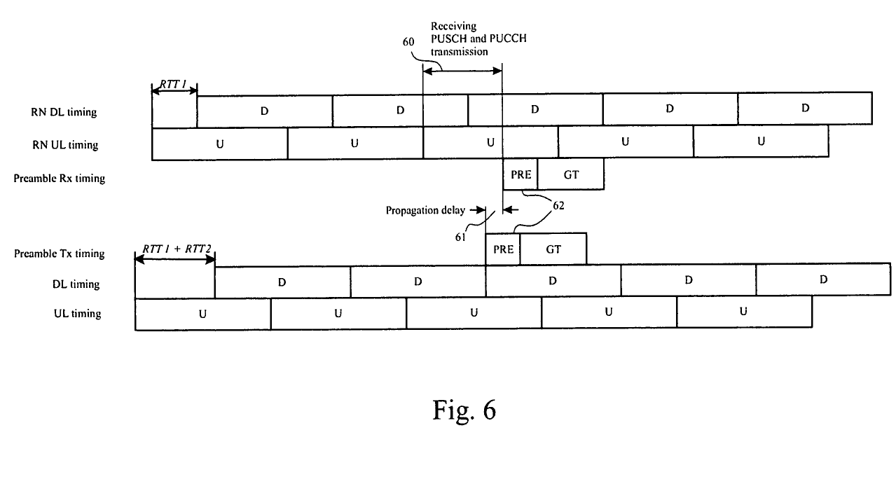

FIG. 6 is a timing diagram illustrating the improved timing with a preamble format according to the present invention. The preamble portion 62 is shorter than the Guard Time GT. It is much easier to fit the shorter preamble portion 62 with the resulting propagation delay to a single uplink subframe, or not to extend the Random Access Preamble to two consecutive uplink subframes. The solution frees radio resources, enabling PUCCH and PUSCH transmission at the beginning of the frame as illustrated with arrow 60.

Embodiments of the present invention may be implemented in software, hardware, application logic or a combination of software, hardware and application logic. In an example embodiment, the application logic, software or instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

If desired, the different functions discussed herein may be performed in a different order and/or concurrently with each other.

Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims.

It is obvious to a person skilled in the art that with the advancement of technology, the basic idea of the invention may be implemented in various ways. The invention and its embodiments are thus not limited to the examples described above; instead they may vary within the scope of the claims.

1. A method in wireless radio communication involving a relay node, the method comprising:
setting a random access message format for establishing a connection between an apparatus for wireless communication and a relay node,
the random access message format comprising a first, a second and a third portion:
the first portion comprising information of the size of a cyclic prefix, the second portion comprising the size of random access information, and the third portion comprising guard time information;
transmitting information about the random access message format consisting of the second portion and the third portion,
prestoring in a memory a value for the first portion,
receiving a second portion of a random access message, and
detecting a received random access message based on the prestored value for the first portion, and on the received second portion.

2. The method according to claim 1, wherein the random access message is a preamble.

3. The method according to claim 2, wherein the preamble format is selected from a group of preamble formats dedicated for wireless apparatus access.

4. The method according to claim 1, wherein the size of the first portion is based on the round trip delay between the relay node and the donor base station and the guard time is based on the distance between the relay node and the donor base station and the size of the relay node cell.

5. The method according to claim 1, wherein the preamble comprises Physical Uplink Shared Channel and Physical Uplink Control Channel transmission if the resource granting system allows granting subframe fractions in time.

6. The method according to claim 1, comprising receiving Physical Uplink Shared Channel and Physical Uplink Control Channel transmission from a second apparatus for wireless communication during the period assigned for the first portion.

7. A relay node for wireless radio communication being configured to:
set a random access message format for establishing a connection between an apparatus for wireless communication and the relay node, the random access message format comprising a first, a second and a third portion:
the first portion comprising information of the size of a cyclic prefix, the second portion comprising the size of random access information, and the third portion comprising guard time information;
transmit information about the random access message format consisting of the second portion and the third portion,
prestore in a memory a value for the first portion,
receive a second portion of a random access message, and
detect a received random access message based on the prestored value for the first portion, and on the received second portion.

8. The relay node according to claim 7, wherein the random access message is a preamble.

9. The relay node according to claim 8, configured to select the preamble format from a group of preamble formats dedicated for wireless apparatus access.

10. The relay node according to claim 7, wherein the size of the first portion is based on the round trip delay between the relay node and the donor base station and the guard time is based on the distance between the relay node and the donor base station and the size of the relay node cell.

11. The relay node according to claim 7, configured to receive a preamble comprising Physical Uplink Shared Channel and Physical Uplink Control Channel transmission if the resource granting system allows granting subframe fractions in time.

12. The relay node according to claim 7, configured to receive Physical Uplink Shared Channel and Physical Uplink Control Channel transmission from a second apparatus for wireless communication during the period assigned for the first portion.

13. An apparatus for wireless communication, being configured to:
receive information of a random access message format for establishing a connection between the apparatus for wireless communication and a relay node, the information disclosing the random access message format comprising a first, a second and a third portion and that only the second and third portion shall be transmitted, and where
the first portion comprises information of the size of a cyclic prefix, the second portion comprises the size of random access information, and the third portion comprises guard time information based on the distance between the relay node and the donor base station and the size of the relay node cell;
generate a random access message based on the random access message format information; and
transmit to the relay node the random access message in a format without the first portion.

14. The apparatus according to claim 13, wherein the random access message is a preamble.

15. The apparatus according to claim 14, configured to select the preamble format from a group of preamble formats dedicated for wireless apparatus access.

16. The apparatus according to claim 13, configured to send a preamble comprising Physical Uplink Shared Channel and Physical Uplink Control Channel transmission if a resource granting system allows granting subframe fractions.

17. The apparatus according to claim 13, configured to receive Physical Uplink Shared Channel and Physical Uplink Control Channel transmission during the period of the first portion from a second apparatus for wireless communication.
